(19) United States
(12) Patent Application Publication
(10) Pub. No.: US 2026/0285678 A1
(43) Pub. Date: Sep. 24, 2026

(54) ENHANCED FEEDSTOCK REFORMING VIA ELECTRICAL RESISTANCE HEATING

(71) Applicant: Blaze Energy Technologies Corporation, Wheat Ridge, CO (US)

(72) Inventor: Jesse E. Hensley, Arvada, CO (US)

(21) Appl. No.: 19/570,507

(22) Filed: Mar. 18, 2026

Related U.S. Application Data
(60) Provisional application No. 63/775,102, filed on Mar. 20, 2025.

(51) Int. Cl. C01B 3/047; F02M 21/02

(52) U.S. Cl. CPC C01B 3/047; F02M 21/0206; F02M 21/0227; C01B 2203/0277; C01B 2203/0283; C01B 2203/085; C01B 2203/1017; C01B 2203/1082

(57) ABSTRACT

A system and method for reforming a hydrogen-containing feedstock. The system includes a flow path defining a passage for a reactant fluid, a metallic substrate, a solid catalyst coating disposed on the metallic substrate, and where the catalyst coating is configured for converting a feedstock to hydrogen and a by-product. A hydrogen-containing chemical can be conveyed across the solid catalyst coating. An electrical current can be passed between a pair of electrodes and through the metallic substrate, heating the metallic substrate and supplying process heat to sustain an endothermic reforming or cracking reaction on the catalyst coating.

### CROSS-REFERENCE TO RELATED APPLICATIONS

This application claims priority to and the benefit of the filing of U.S. Provisional Patent Application No. 63/775,102, entitled “Enhanced Feedstock Reforming Via Electrical Resistance Heating”, filed on Mar. 20, 2025, and the specification thereof is incorporated herein by reference.

### BACKGROUND OF THE INVENTION

Embodiments of the present invention relate to catalytic thermal reforming of a feedstock (also known as cracking) and the operation of internal combustion engines fueled in whole or in part by fuel liberated from such cracking. Embodiments of the present invention thus provide an efficient and economic method and apparatus that allows the fueling of traditional internal combustion engines with different fuels, including but not limited to ammonia, methanol, ethanol, methane, petroleum naphtha, and/or natural gasoline and other hydrogen-containing feedstocks that can liberate hydrogen when the feedstock is cracked, thus reducing carbon dioxide (“CO2”) emissions. Throughout this application, reference is repeatedly made to ammonia and/or NH3. It is to be understood that the mention of such materials is merely exemplary and is intended to also include any and all other feedstocks that can liberate hydrogen by cracking.

Energy sources that are renewable and/or substantially free of CO2 emissions are highly sought after in both developed and developing countries. Carbon-free energy, for difficult to abate sectors including but not limited to heavy equipment and maritime shipping, is especially needed. Heavy equipment and ships most often generate motive power through the combustion of fuels in internal combustion engines. Electricity generating equipment, especially in remote locations, often relies on internal combustion engines to produce power.

### BRIEF SUMMARY OF EMBODIMENTS OF THE PRESENT INVENTION

Embodiments of the present invention relate to a system for reforming a hydrogen-containing feedstock including a housing at least partially defining an enclosed reactant fluid flow path, an electrically conductive heating element substrate disposed within the enclosed reactant fluid flow path, a catalyst coating disposed on at least a portion of the electrically conductive heating element substrate, the catalyst coating comprising a catalyst material capable of catalytically facilitating the conversion of a hydrogen-containing feedstock into hydrogen and a byproduct, and at least one electrode disposed or otherwise formed onto the electrically conductive heating element substrate. The electrically conductive heating element substrate can be formed from an austenitic stainless steel or nickel-containing alloy, which itself comprises at least 50% nickel, and the electrically conductive heating element substrate can have a surface oxide layer over at least a portion of its surface. The catalyst coating can include a metal oxide support chemically bound to the surface oxide layer. In addition, the catalyst coating can include a catalytic metal bound to the metal oxide support. The metal oxide support can include at least one of aluminum oxide, magnesium oxide, cerium oxide, lanthanum oxide, iron oxide, calcium oxide, barium oxide, titanium oxide, and/or praseodymium oxide. The metal oxide support can also include at least one of an alkali and an alkaline-earth promoter. The catalyst coating can optionally include one or more of a metallic: iron, cobalt, nickel, copper, palladium, ruthenium, rhodium, silver, molybdenum, tungsten, rhenium, osmium, platinum, nitrides, oxides, carbides, oxynitrides, oxycarbides and an alloy thereof.

In one embodiment, the housing defining an enclosed reactant fluid flow path can include a plurality of housings defining an enclosed reactant fluid flow path and the plurality of housings can be arranged in series to provide a single continuous fluid flow path. The system can also include an additional catalytic reactor that does not have an electrically conductive heating element substrate. The additional catalytic reactor can be positioned downstream of the electrically conductive heating element substrate in the enclosed reactant fluid flow path. The additional catalytic reactor can include a catalyst that can be one or more of a particle, pellet, agglomerate, extrudate, tablet, coated ceramic solid, coated metallic solid, coated ceramic honeycomb monolith, and/or coated metallic honeycomb monolith. The housing and the electrically conductive heating element substrate can be formed from one or more materials that can be chemically tolerant of ammonia and/or hydrogen within a temperature range of 0 degrees Celsius to 650 degrees Celsius. In one embodiment, the system can also include a controller configured to receive a process measurement indicative of hydrogen concentration in an outlet stream from the enclosed reactant fluid flow path, compare the process measurement to a target corresponding to a desired partial conversion of the hydrogen-containing feedstock, and adjust at least one of electrical power applied to the electrically conductive heating element substrate, and a flow rate of the feedstock—the controller can be configured to make the adjustment to maintain the hydrogen concentration within a predetermined range and/or to maintain the desired partial conversion within a predetermined range.

Optionally, the controller can be further configured to receive a process measurement representing temperatures of fluid flowing through the enclosed flow path and/or in an outlet stream of the enclosed flow path, compare one or more of the process measurements to the desired operating temperature, and make the adjustment based thereon. The electrically conductive heating element substrate can include a sheet, foil, wire, and/or a monolith. The system can be configured for use as a fuel system for an internal combustion engine having a hydrogen-containing feedstock tank; one or more heat exchangers configured to vaporize and preheat feedstock from the feedstock tank, a power source, the power source electrically coupled to provide power to the electrically conductive heating element substrate, and the enclosed reactant fluid flow path coupled such that it can receive the vaporized and preheated feedstock, and a control unit configured to adjust one or more of 1) electrical power to the electrically conductive heating element substrate and/or 2) a flow of the hydrogen-containing feedstock. The control unit can be configured to make the adjustment in response to at least one of engine load and fuel demand. The one or more heat exchangers can be configured to derive heat from at least one of circulating engine coolant, engine exhaust, flue gas, seawater, and process steam. The power source can include a battery that can be connected such that it can be charged, at least partially, by work performed by the internal combustion engine. Optionally, the power source can be one which derives its energy from something other than the internal combustion engine.

In one embodiment, the fuel system can be thermally and electrically integrated with the internal combustion engine. In one embodiment, however, the fuel system can be not thermally and electrically integrated with the internal combustion engine and instead can be coupled to derive input energy from sources other than the internal combustion engine. The internal combustion engine can include a two-stroke engine, a four-stroke engine, and/or a turbofan engine. The internal combustion engine can use at least one of compression ignition and spark ignition. The internal combustion engine can derive at least a portion of its combustion energy from hydrogen gas liberated by the catalyst coating on the electrically conductive heating element substrate.

Embodiments of the present invention also relate to a method of reforming a hydrogen-containing chemical that includes flowing the hydrogen-containing chemical across a catalyst coated on an electrically conductive heating element substrate, which is disposed within a flow path of the hydrogen-containing chemical in order to liberate hydrogen gas and byproducts, making an adjustment to: 1) electrical power applied to the electrically conductive heating element substrate, and/or 2) a flow rate of the hydrogen-containing chemical. Optionally, making the adjustment can include making the adjustment to maintain at least one of a hydrogen concentration, a desired partial conversion of the hydrogen-containing chemical to the hydrogen gas, and a temperature. Optionally, the temperature can be a temperature of the substrate and the temperature can be a temperature within a range of 250 degrees Centigrade to 850 degrees Centigrade. In one embodiment, the desired partial conversion of the hydrogen-containing chemical to the hydrogen gas can include an extent of conversion of between 7% and 99%. In the method, making an adjustment can include making a step adjustment to the electrical power applied to the electrically conductive heating element substrate by at least 10% and causing a step change in the conversion of the hydrogen-containing chemical to the hydrogen gas and the byproducts within less than 5 seconds. The method can also optionally include selecting the hydrogen-containing chemical, from one or more of: ammonia, methanol, methane, ethanol, petroleum naphtha, and/or natural gasoline, and the method can also include operating the electrically conductive heating element substrate at a temperature sufficient to achieve at least 98% conversion of the hydrogen-containing chemical to the hydrogen gas and the by-products. The method can also include adding steam to the hydrogen-containing chemical and reducing the formation of carbon deposits on the catalyst while also causing a water gas shift reaction to produce more of the hydrogen gas.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1A is a drawing which illustrates a conventional gas fired tubular reforming reactor, the tube(s) containing bed(s) of solid reforming catalyst particles, tablets, extrudates, or agglomerates;

FIG. 1B is a drawing which illustrates a conventional heat exchanger reactor with reaction occurring within the process tubes of the heat exchanger, containing bed(s) of solid reforming catalyst particles, tablets, extrudates, or agglomerates;

FIG. 2 is a drawing which illustrates an electrically conductive heating element substrate contained within and electrically isolated from an enclosed fluid flow path according to an embodiment of the present invention;

FIG. 3A is a diagram which illustrates a perspective view of an electrically conductive heating element substrate coated with a solid catalytic material, according to an embodiment of the present invention;

FIG. 3B is a diagram which illustrates a side view of the metallic substrate coated with the solid catalytic material of FIG. 3A, according to an embodiment of the present invention;

FIG. 4A is a drawing which schematically illustrates heat flow from a bulk hot fluid through a metal tube or pipe wall, into a bulk reactant fluid, and into solid catalyst particles, according to an embodiment of the present invention;

FIG. 4B is a chart that illustrates a relative change in temperature between bulk hot fluid and catalyst particle surfaces as heat flows through the fluid and solid interfaces of the configuration of FIG. 4A;

FIG. 4C is a drawing that schematically illustrates heat flow from an electrically conductive heating element substrate through a catalyst coating and into a bulk reactant fluid, according to an embodiment of the present invention;

FIG. 4D is a chart that illustrates a relative change in temperature between the electrically conductive heating element substrate of FIG. 4C and the bulk reactant fluid as heat flows through fluid and solid interfaces;

FIG. 5A is a graph which illustrates typical response behavior in a reforming load in the thermal catalytic reformers that are illustrated in FIGS. 1A-1B and FIG. 4A for a step change increase in hot fluid temperature;

FIG. 5B is a graph which illustrates typical response behavior in a reforming load in the thermal catalytic reformers that are illustrated in FIGS. 2-3B and FIG. 4C for a step change increase in power input;

FIG. 6 is a graph which illustrates changes in the temperature and hydrogen content of a fluid when the power to an electrically-heated catalytic reformer is adjusted;

FIG. 7 is a drawing which illustrates the electrically conductive heating element substrate and flow path of FIG. 2 used as a chemical reactor whereby a flowing reactant fluid is catalytically converted to a flowing product fluid as it flows past a catalyst-coated, electrically conductive heating element substrate according to an embodiment of the present invention;

FIG. 8 is a drawing which illustrates the flow reactor of FIG. 7 applied to the fueling of an internal combustion engine, according to an embodiment of the present invention;

FIG. 9 is a drawing which illustrates the flow reactor of FIG. 7 applied to the fueling of an internal combustion device that is not fully integrated with the electrically heated reactor, according to an embodiment of the present invention;

FIG. 10A is a drawing which illustrates the electrically conductive heating element substrate and flow path of FIG. 2 in series with an unheated catalytic reactor, according to an embodiment of the present invention;

FIG. 10B is a series of example configurations which illustrate electrically conductive heating element substrates and unheated catalytic reactors arranged within a single flow path, according to an embodiment of the present invention; and

FIG. 11 is a block diagram illustrating an example computer control system that can be used, according to an embodiment of the present invention.

### DETAILED DESCRIPTION OF THE INVENTION

Embodiments are described more fully below with reference to the accompanying figures, which form a part hereof and show, by way of illustration, specific exemplary embodiments. These embodiments are disclosed in sufficient detail to enable those skilled in the art to practice the disclosed embodiments. However, embodiments can be implemented in many different forms and should not be construed as being limited to the embodiments set forth herein. The following detailed description is, therefore, not to be construed as limiting the invention.

Hard-to-abate energy sectors including, for example, maritime shipping and transport, airplanes, power generating turbines, large stationary generators, and heavy equipment have been seeking methods to reduce their production of CO2 emissions via electrification, efficiency improvements, carbon capture and sequestration, and alternative fuels with lower carbon emissions per unit of useful work delivered. Carbon-free or carbon-neutral fuels are of special interest because if produced using renewable methods, they can allow the use of existing power delivery systems and infrastructure while achieving substantially reduced CO2 emissions. Alternative fuels are of interest in general to diversify the choices available to large energy consumers like heavy vehicles and watercraft, data centers, and community power grids.

Ammonia (NH3) is a carbon-free molecule that can be combusted as a fuel according to the exothermic reaction (1):

4NH3+3O2→2N2+6H2O (1)

NH3 can also be used as a hydrogen (H2) carrier. When heated in the presence of a reforming catalyst, NH3 decomposes to H2 and nitrogen (N2) according to the endothermic reaction (2):

2NH3→3H2+N2 (2)

H2 can similarly be combusted as a fuel according to the exothermic reaction (3):

2H2+02→2H2O (3)

Thus, NH3 or its derivative H2, could be used as a fuel in engines for hard-to-abate sectors.

When NH3 is reformed (reaction 2), heat is required to drive the endothermic reaction in the amount of 46.2 kilojoules (kJ) per mole of NH3. The reaction proceeds at temperatures between about 400° C. to about 700° C. and sometimes below 400° C. and sometimes above 700° C. Therefore, heat must be supplied continuously to an NH3 reforming reactor to prevent cooling below reaction temperature, which will stop all reforming activity.

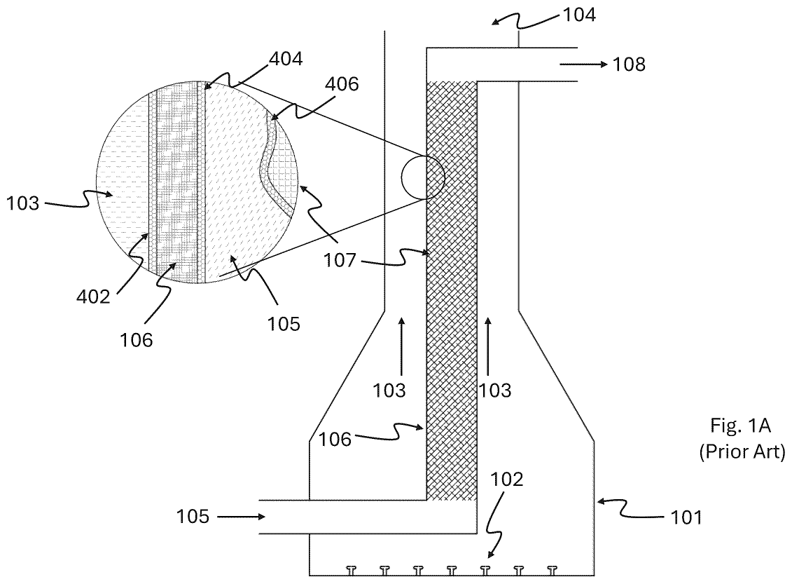

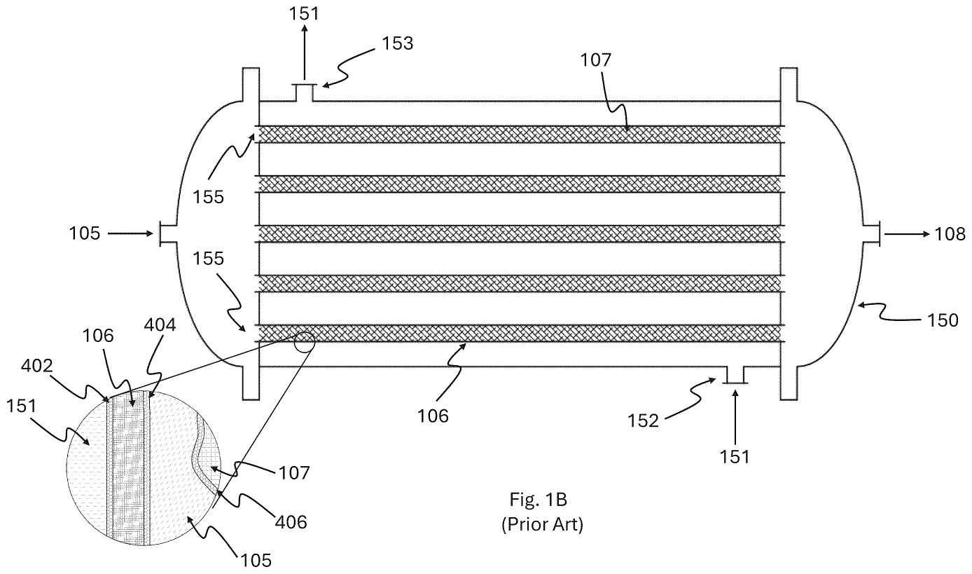

Most industrial reformers provide heat for the reforming reaction through combustion of fuel gas (FIG. 1A) or exchange from a flowing hot fluid that is at a temperature greater than the reforming reaction (FIG. 1B). Specifically in FIG. 1A, furnace 101 is fired through burners 102 to provide process heat via combustion gases 103 with exhaust gases exiting stack 104. Reactant fluid 105 flows into tube(s) 106 to contact packed bed catalyst 107 whereupon the reforming reaction occurs, with heat provided by combustion gases 103 and heat transfer through tube(s) 106 into reactant fluid 105, resulting in reformed product stream 108. Specifically in FIG. 1B, heat exchanger reactor 150 is fed with hot process fluid 151 that enters the exchanger jacket at nozzle 152 and exits at nozzle 153 to provide process heat. Reactant fluid 105 flows into tube bank 155 to contact packed bed catalyst 107 whereupon the reforming reaction occurs, with heat provided by hot process fluid 151 and heat transfer through tubes 106 comprising tube bank 155 into reactant fluid 105, resulting in reformed product stream 108. In both cases, heat flows from the hot combustion gases or hot fluid to the cold reaction fluid, passing through a physical barrier that separates the heating fluid and reacting fluid (for example a metal pipe or tube). For an endothermic reaction that occurs on a solid catalyst, this means that the surface of the catalyst (where the reaction occurs) will always be the coldest part of the system and the combustion gases or hot fluid will always be the hottest part of the system when steady reforming is occurring.

The reforming reaction (reaction 2) is kinetically limited, meaning that the rate of reaction will be influenced by the concentrations of NH3, H2, and N2 as well as the temperature at the surface of the reforming catalyst. For reaction 2, it is known that higher temperatures result in faster reaction rates according to equation (4):

rate αexp(−Eₐ/RT) (4)

where the symbol “α” indicates “proportional to”, Eₐ is the activation energy for the reaction, R is the universal gas constant, and T is the absolute temperature. For reactions that must overcome an activation barrier Eₐ, including the NH3 reforming reaction, the higher the activation barrier, the larger the influence of higher temperatures on reaction rates.

As the temperatures of system components increase, the system becomes more expensive and complex for the following reasons: a) fewer options exist for materials that can withstand high temperatures, limiting materials of construction to fewer and typically less available and more expensive options; b) the flux of heat is a function of the difference in temperatures between the hot source of heat and cold sink for heat. The surroundings in which the system resides represent an unavoidable parasitic cold sink equivalent to ambient temperature and with a large heat capacity. To prevent loss of heat to surroundings, more insulation (more material and more space consumed) is required to prevent parasitic heat loss; and c) barriers that separate hot (heat providing) and cold (heat receiving) fluids resist heat flow. As these barriers become thicker to maintain mechanical integrity (which decreases as materials are heated), the resistance to heat flow increases, resulting in a larger required difference in hot and cold temperatures to achieve the same heat flow.

In large stationary industrial operations, the approach of heating a reforming reaction via combustion of fuel gas or exchange with a hot process fluid (FIG. 1A and FIG. 1B) are acceptable because a) economies of scale can be leveraged to minimize equipment (capital) cost per flow of reformed NH3, b) other portions of the plant may produce “waste” steam or hot fluids that can be supplied to provide heat for the reforming reaction and c) fuel gas may be available in larger quantities than other energy sources like electricity or steam. However, in small or mobile applications, it may be prohibitively expensive and space-consuming to perform reforming reactions according to the heat transfer strategies of FIG. 1A and FIG. 1B.

An additional feature of industrial reforming is that the reforming reactor is designed to operate at a steady rate of reaction and extent of reaction (typically as close to equilibrium conversion as possible). As such, the heat exchange approach shown in FIG. 1A and FIG. 1B, which is slow to heat, slow to cool, and slow to change, is an acceptable strategy. However, some applications—for example, the fueling of internal combustion engines with H2/N2/NH3 mixtures, may require rapid changes in both the flow of reformed NH3 and the extent of NH3 conversion. Applications are not limited to NH3 and could include any reformed fluid with dynamic or variable downstream demands.

Therefore, a method and apparatus are needed to perform endothermic reforming reactions, including for example the reforming of NH3 to form H2 and N2, at smaller scale and/or for mobile applications, which does not require the generation of a hot heat transfer fluid and subsequent heat exchange with a reacting fluid, which can include for example NH3. The method and apparatus must also improve the speed at which a reforming reaction's rate is changed—for example, the rate of NH3 reforming.

Embodiments of the present invention relate to a method and apparatus to rapidly and dynamically heat a catalytic reforming reaction without the need for a heat transfer fluid.

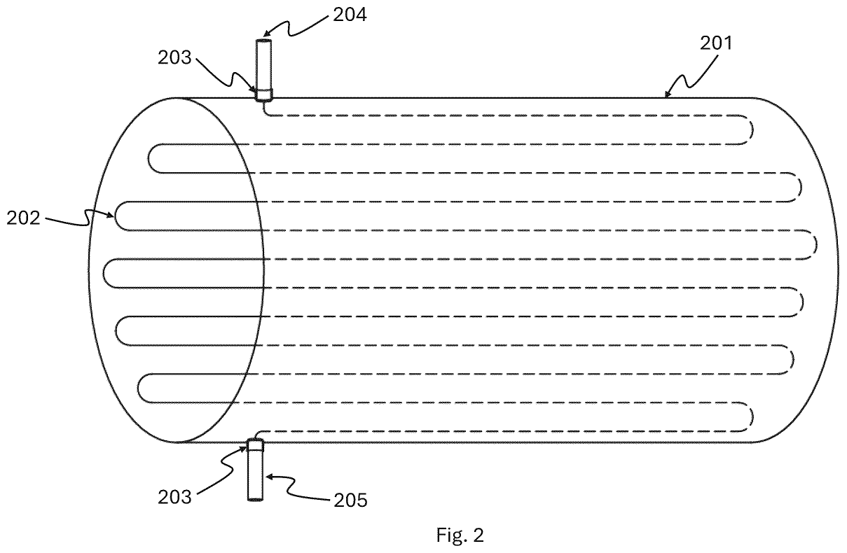

FIG. 2 illustrates an embodiment of a substrate 202, which is preferably formed from an electrically conductive heating element, (the substrate referred to herein generally as “substrate” and/or “electrically conductive heating element substrate”). Substrate 202 is preferably coated with a catalyst. Thus, when reference is made to the substrate being positioned or disposed somewhere, the catalyst is thus also preferably present. Housing 201 contains flowing reactant fluid, which can include for example gaseous NH3, and routes it through, past, along, and/or otherwise over the heated substrate. In one embodiment, substrate 202 is preferably electrically isolated from the housing with insulators or insulating potting 203. Optionally, however housing 201 can be formed from an electrically non-conductive material which is capable of withstanding temperatures generated by electrically conductive heating element substrate 202, including but not limited to ceramics. Electrical current is applied to electrode 204, passes through substrate 202, and through a second electrode (electrode 205). Optionally, however, second electrode 205 can be coupled to housing 201 (for embodiments wherein housing 201 is electrically conductive), such that housing 201, or a portion thereof can form a portion of a return path for electricity flowing through substrate 202. In one embodiment, electrodes 204 and/or 205 can be a stud or other electrical connection that is electrically coupled to substrate 202. Optionally, however, electrodes 204 and/or 205 need not actually be a separate piece of material coupled to substrate, instead, one or more end portions of substrate 202 can simply be formed into a shape and size that is configured to be received into or otherwise attached onto a wire or other conductor (including but not limited to one or more portions of housing 201). For example, one or both end portions of substrate 202 can comprise a spade shape or prong shape which is received into an electrical connector. In one embodiment, electrically conductive heating element substrate 202 is preferably selected and configured for electricity to flow through it and to thus generate heat within substrate 202 due to its electrical resistance. In one embodiment, substrate 202 is not merely some separate piece of material that attaches to or otherwise is heated by a heating element that is not substrate 202.

Substrate 202 can be in any desired shape, including but not limited to strips, foils, or wires, of any metal or metal alloy. In one embodiment, substrate 202 is preferably sufficiently rigid to prevent the substrate from sagging, drooping, or folding and contacting housing 201, including when under viscous forces from flowing fluids. Depending on the material from which housing 201 is formed, desirable results may be obtained even when substrate 202 contacts housing 201—for example if housing 201 is formed from a non-conductive material and is capable of withstanding the temperatures that can be created by electrically conductive heating element substrate 202, then substrate 202 can optionally be placed in direct contact with housing 201 at one or more locations (including optionally along an entire length of substrate 202). Both alternating current (AC) and direct current (DC) power can be applied to electrode 204 and electrode 205, with maximum voltage dictated by the spacing between electrodes and the dielectric properties of the fluid passing the energized substrate. The electrical resistance (R) between electrode 204 and electrode 205 dictates the power (P) applied to the substate according to equation (5):

P=V\hat{ }2/R (5)

Where V is the voltage applied between electrode 204 and electrode 205. The electrical current (I) carried by the substrate is given by equation (6):

I=V/R (6)

The passage of current (I) through substrate 202 with resistance (R) results in heating of substrate 202. Embodiments of the present invention preferably use this electrical resistance heating to provide heat for endothermic reforming reactions, including for example NH3 reforming.

Although FIG. 2 shows an electrically isolated metal substrate in a metal tube or pipe, the apparatus used to contain a metallic resistive heating element within a flow passage is not limited in geometry, and the flow passage is not limited in materials of construction. Optionally, such flow paths can be constructed of ceramic or polymeric materials. Common to all embodiments is the movement of a reactant fluid, by forced or natural convection, past an electrically-heated substrate, with heat used to maintain an endothermic catalytic reaction, at temperatures suitable for reactant conversions from about 5% to about 100%.

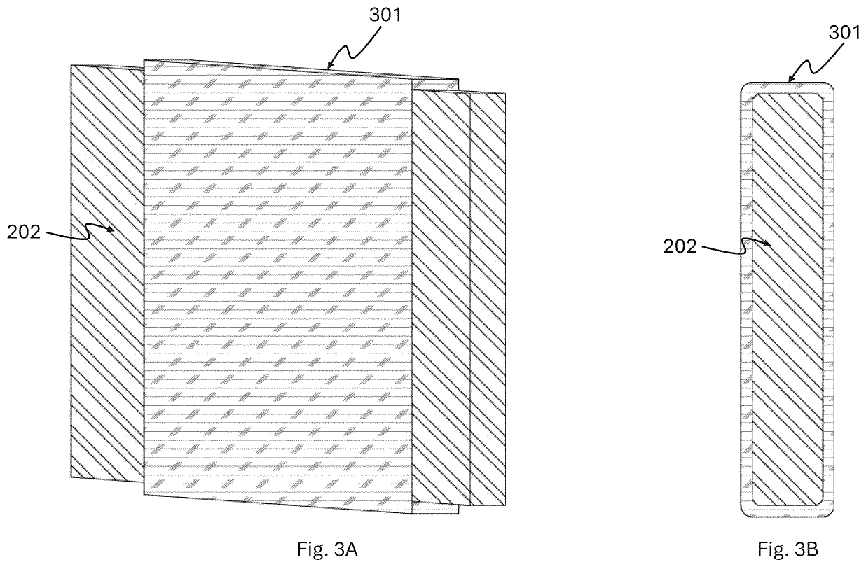

FIGS. 3A and 3B illustrate an embodiment wherein a solid reforming catalyst has been applied to substrate 202, which can optionally be a heated metal substrate. In some embodiments, a layer of catalyst coating 301 is applied to the surface of substrate 202 by methods known to those skilled in the art, including dip coating, wash coating, spray coating, painting, electrostatic deposition, atomic layer deposition, or chemical vapor deposition. In some embodiments the catalyst coating is adhered to substrate 202 and/or cured to its catalytically-functional form through drying, calcining in air, enriched air, inert gas, and/or chemical reduction. In some embodiments, substrate 202 can be prepared for coating by thermal or chemical pretreatments that alter the surface chemistry and/or morphology of the substrate to improve adhesion of the catalyst coatings and/or to influence the catalytic properties of the coatings. In some embodiments only one coating is applied. In other embodiments, 2, 3, 4, or any larger number of coatings are applied, with 0, 1, or more thermal or chemical treatments between coatings. In some embodiments, the total thickness of all coatings ranges from as little as about 2 micrometers to as much as about 200 micrometers. In some embodiments, the thickness of the coating(s) is/are non-uniform and in still other embodiments the thickness of the coating(s) is/are uniform. In some embodiments, catalyst coating 301 resembles solid particles adhered to a smooth surface. In still other embodiments, catalyst coating 301 resembles a smooth surface adhered atop a smooth substrate when magnified such that surface roughness of the substrate is not observable but additional magnification would start to show roughness on the substrate surface.

In one embodiment, catalyst coating 301 applied to substrate 202 is catalytically active for NH3 reforming. The coating can be any solid phase NH3 reforming catalyst known to those skilled in the art, including ruthenium particles deposited on a metal oxide. In other embodiments, catalyst coating 301 applied to substrate 202 is catalytically active in the reforming of methanol, ethanol, methane, petroleum naphtha, natural gasoline and/or other hydrogen-containing feedstocks. The coating can include, but is not limited to, any solid phase reforming catalyst known to those skilled in the art.

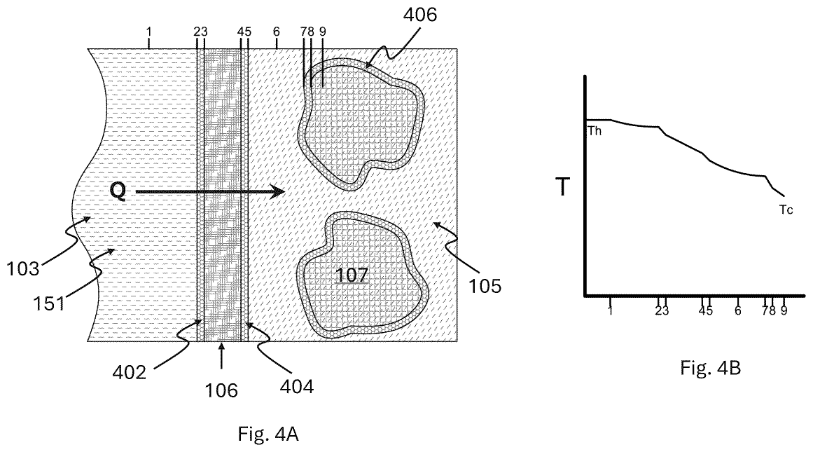

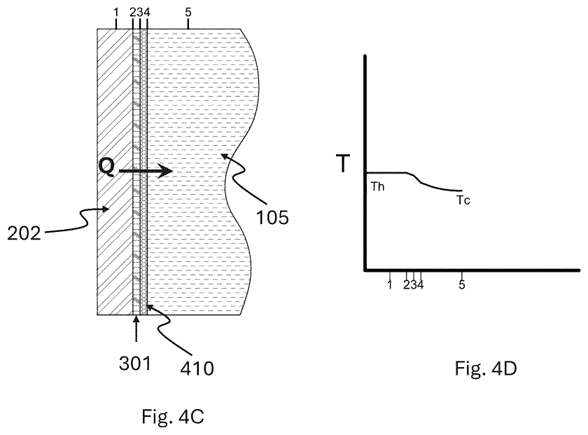

FIGS. 4A and 4C illustrate temperature profiles that exemplify an advantage of using an electrically heated reforming catalyst to transfer heat to a reaction. FIG. 4B illustrates a typical temperature profile in the industrial reformer of FIGS. 1A and 1B. As heat (Q) flows from combustion gases 103 or hot process fluid 151 to packed bed catalyst 107 to drive the endothermic reforming reaction, it encounters heat transfer resistances in combustion gases 103 or hot process fluid 151, a stagnant fluid boundary layer at outer pipe wall 402, tube 106, a stagnant reactant fluid boundary layer at inner pipe wall 404, reactant fluid 105, a stagnant reactant fluid boundary later at catalyst surface 406, and solid packed bed catalyst 107. As heat flows from hot fluid to cold catalyst surface (reference numbers 1-9 in FIG. 4A and FIG. 4B), the temperature drops from hot (Th) to cold (Tc). Net heat flow must be sufficient to overcome the endothermic heat of reaction. For example, for NH3 reforming, at least 46.6 kJ per mole of NH3 must transfer from combustion gases 103 or hot process fluid 151 to cold packed bed catalyst 107. The temperature, and thus speed, of the reforming reaction will adjust according to available heat flow until steady state is achieved. The overall heat flux (F) is given by equation (7):

F=h*(Th−Tc) (7)

Where h is the net heat transfer coefficient. A low resistance to heat transfer results in high values of h (rapid heat transfer) and a high resistance to heat transfer results in low values of h (slow heat transfer). In the example system of FIG. 4A, the net heat transfer resistance results from the sums of convective heat transfer resistances in hot fluid and reactant fluid and conductive heat transfer resistances through stagnant fluid boundary layers and solid pipe and catalyst. Therefore, a larger number of heat-resistive pathways results in a lower value for h. Because Tc will dictate the minimum temperature for viable reforming, the only way to increase the reforming rate is to increase Th well above reaction temperature.

FIGS. 4C and 4D illustrate a typical temperature profile in the coated, electrically-heated substrate of FIGS. 2, 3A, and 3B. Because heat is generated in substrate 202, which is intimately bonded to catalyst coating 301, Q flows from substrate 202 (generally uniform in temperature) to the surface of catalyst coating 301 where it provides heat to the endothermic reforming reaction, then through the stagnant reactant fluid boundary layer 410 at the catalyst surface and into reactant fluid 105. In this embodiment, Th is the reactant temperature, readily controlled via a microcontroller and/or proportional integral derivative (PID) or pulse width modulated (PWM) control of the electrically-heated substrate 202, with rapid response. Tc results from the removal of heat by the reaction endotherm and mixing of colder reactant fluid with hotter product fluid.

The fundamentals of heat transfer suggest that the heating of a reforming reaction using traditional methods (FIGS. 1A and 1B, FIG. 4A) will require fluid temperatures in excess of the desired reforming reaction temperature and a slow response to a change in temperature Th of combustion gases 103 or hot process fluid 151, as fluid, pipe, and catalyst temperatures take up or lose heat according to their thermal masses and bulk value of h, which is a function of fluid properties, fluid velocity, system geometry, and physical properties of pipe and catalyst solids. The requirement that Th is hotter than reaction temperature adds the need for more energy input to the process (to achieve Th of hot fluid), more insulation (to prevent energy loss from higher heat flux to surroundings), and potentially thicker walled pipe, which increases structural complexity and capital expense.

Similarly, the fundamentals of heat transfer suggest that the heating of a reforming reaction using a catalyst-coated electrically-heated substrate (FIGS. 3A, 3B, and FIG. 4C) will minimize energy input for the reforming reaction and afford rapid changes in reaction temperature as electrical heating of substrate 202 is nearly instantaneous and because the net path for heat transfer to the catalyst surface is on the order of micrometers instead of centimeters.

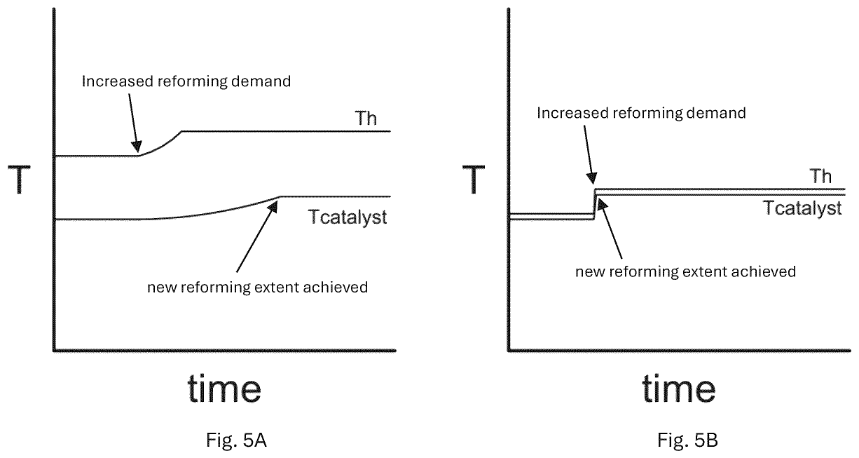

The impact on reaction control and temperature change dynamics is illustrated in FIGS. 5A and 5B, which show conceptually the difference in response time between a step change increase in hot fluid temperature (traditional reforming, shown in FIG. 5A) and a step change increase in power input (catalyst-coated electrically-heated substrate, shown in FIG. 5B), respectively. As the figures illustrate, the traditional reformer is unable to respond quickly to an increased demand in reforming capacity or extent of conversion, while the electrically heated substrate responds rapidly.

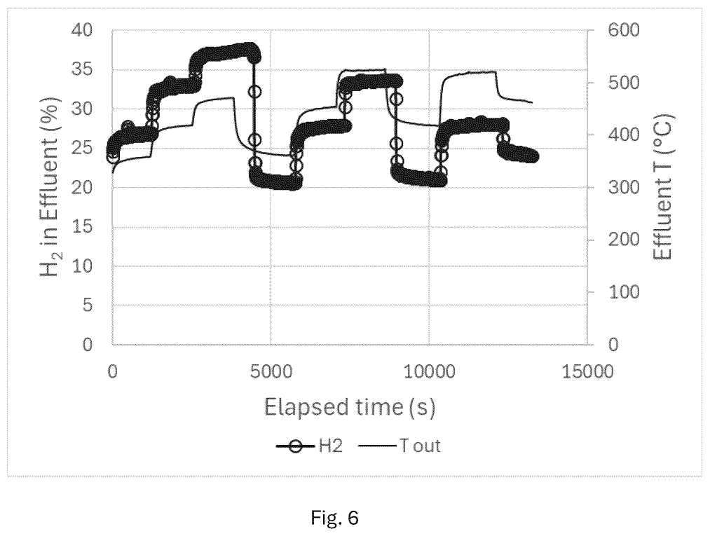

The responsiveness of changes to power input on fluid temperature and extent of reforming are illustrated in FIG. 6, which shows data from an experiment where a stream of NH3 was reformed into a mixture of NH3, H2, and N2. FIG. 6 shows the extent of reforming reported as the percentage H2 in the effluent gas. The power provided to an electrical heater coated with an NH3 reforming catalyst was changed several times, and the resulting changes in the H2 concentration and effluent temperature were shown to adjust rapidly, matching the conceptual graph of FIG. 5B.

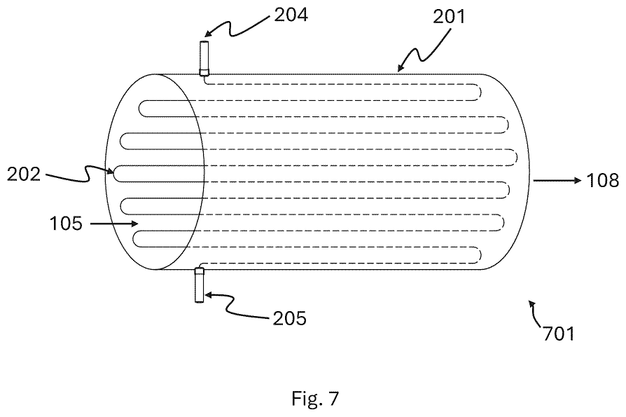

In one embodiment, as illustrated in FIG. 7, a stream of reactant fluid 105 is passed through reactor 701 (sometimes referred to herein as a “reformer” or “reforming reactor”) comprising an electrically isolated substrate 202 located within an enclosed flow path. To be clear, the “enclosed” flow path can have one or more inlets and one or more outlets but is most preferably at least generally otherwise sealed. In addition, by substrate 202 being “disposed” within the flow path, it is intended to include not only positioned within the flow path, but substrate 202, with a coating thereon can itself help to define or otherwise enclose the flow path. The substrate is coated with reforming catalyst coating 301 (see FIG. 3A). The temperature of substrate 202 is preferably controlled by pulsing electrical current between electrode 204 and electrode 205 (for example using a solid-state relay to effect pulse-width modulation) to achieve a substrate surface temperature at a thermocouple that is welded or otherwise coupled to the substrate. This can include using a velocity-type PID algorithm. Reformed product stream 108 flows out of an enclosed flow path and the extent of reforming (conversion) of reactant fluid 105 is dependent on the flow rate of reactant fluid 105, the temperature of substrate 202, the properties of catalyst coating 301 applied thereto (see FIG. 4C), and the geometry of substrate 202 and housing 201. As the temperature of the substate is increased by an operator (more electrical current delivered to the substrate), the reactant conversion increases.

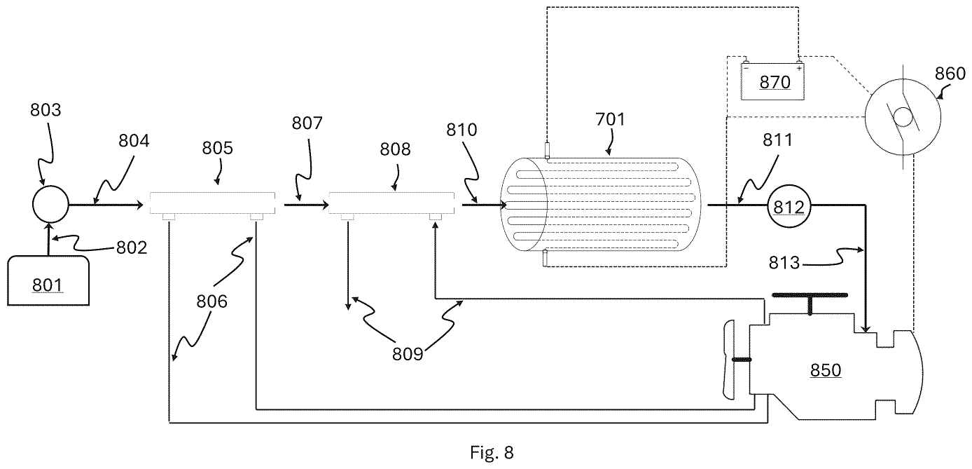

In one embodiment, as illustrated in FIG. 8, the electrically heated reactor of FIG. 7 is preferably incorporated into, or otherwise coupled to, an engine fueling system. Tank 801 provides liquid NH3 802 that is regulated to a desired pressure through regulator 803. The reduced-pressure NH3 804 is fully vaporized through heat exchanger 805 via exchange with circulating hot engine coolant 806. Gaseous NH3 807 passes through heat exchanger 808 where it is heated with engine exhaust 809. Preheated NH3 vapor 810 is fed to electrically-heated reactor 701 where it contacts catalyst coating 301 (FIG. 3A) on electrically heated substrate 202 (FIG. 3A) to form a mixture of H2 and N2 according to H2/NH3 requirements of engine 850. Electricity for the reformer is preferably supplied via battery 870, which is preferably continuously recharged from alternator 860 (which can optionally comprise a generator), which is preferably coupled to and thus powered by engine 850. Hot NH3/H2/N2 gases 811 pass through a liquid or air-cooled heat exchanger 812 to cool below maximum fuel delivery temperature (as specified by the engine manufacturer). Cooled fuel stream NH3/H2/N2 813 then flows to the port of engine 850 where it is used to generate power via internal combustion. When engine 850 demands more fuel or a different mixture of NH3/H2, reactor 701 preferably adjusts power input to substrate 202 (FIG. 3A) to increase or decrease the rate of NH3 reforming.

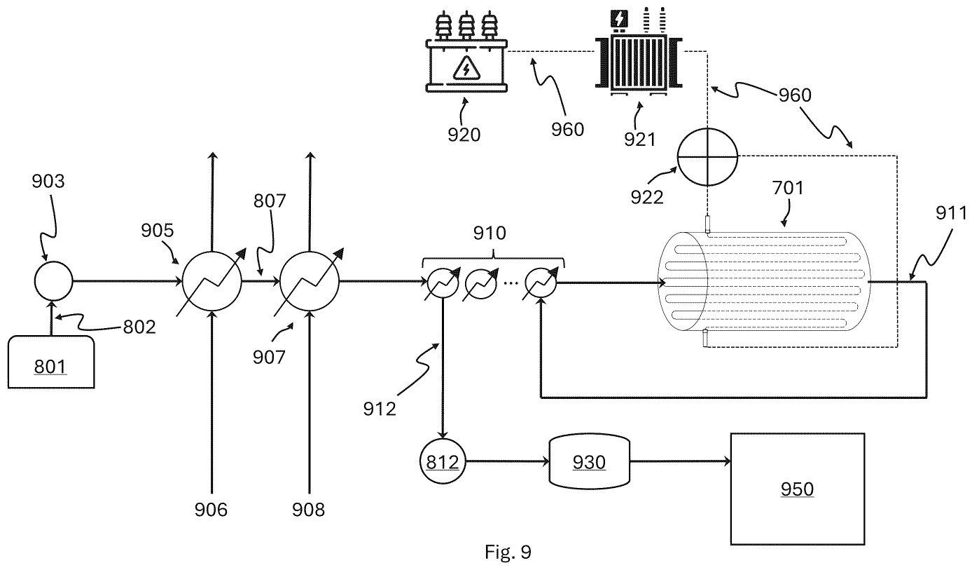

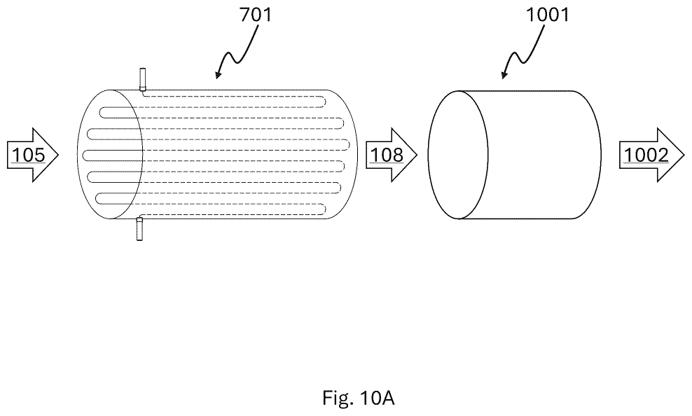

In one embodiment, as illustrated in FIG. 9, the electrically heated reactor of FIG. 7 is used to provide H2 or a mixture of NH3 and H2 to a combustion device that is not fully integrated with the electrically heated reactor. For example, the propulsion engine on a ship may utilize the H2 produced by the electrically heated reactor while a separate generator provides the electricity to the reactor, and utilities not fluidly connected to the propulsion engine add or remove heat from the NH3 and/or H2 streams. Tank 801 provides liquid NH3 802 that enters flow controller 903 which modulates flow according to fuel demand. Liquid or mixed liquid and gaseous NH3 802 then flows through heat exchanger 905 to vaporize the NH3 by extracting heat from warm or hot fluid 906. Warm or hot fluid 906 can be any desired fluid, including but not limited to, engine exhaust, flue gas, circulating coolant, seawater, steam, or any other warm or hot fluid that can exchange heat with liquid NH3 to satisfy the heat of vaporization. Gaseous NH3 807 passes through optional heat exchanger 907 to preheat gaseous NH3 by extracting heat from warm or hot fluid 908. Warm or hot fluid 908 can be any desired, including but not limited to, engine exhaust, flue gas, circulating coolant, seawater, steam, or any other warm or hot fluid that can exchange heat with gaseous NH3 to increase its temperature. In some embodiments, both vaporization and preheating of liquid NH3 802 is achieved in heat exchanger 905 by extracting heat from warm or hot fluid 906. Flow controller 903 can optionally be located downstream of heat exchanger 905 or heat exchanger 907. Gaseous and optionally preheated NH3 flows through optional economizer 910, which can be one, two, three, or any number of heat exchangers arranged in series, wherein hot reactor effluent 911 transfers heat to gaseous NH3 to preheat it prior to entering reactor 701. Partially cooled effluent 912 (for example, NH3, H2, and/or N2 gases) passes through a liquid or air-cooled heat exchanger 812 to cool below maximum fuel delivery temperature as specified by the manufacturer of a downstream combustion device (combustion device 950). Optionally, tank 930 maintains an accumulated volume of NH3/H2/N2 gases to accommodate sudden increases in fuel demand from combustion device 950, allowing reactor 701 and flow controller 903 several seconds or minutes to adjust to the change in fuel demand from combustion device 950. Electrical power is delivered from source 920 through optional transformer 921 and power controller 922, which modulates electrical current and/or voltage to electrically conductive heating element substrate 202 (FIG. 2) within reactor 701, through wires 960. Delivered power from power controller 922 is modulated based on the desired conversion of NH3 within reactor 701 and the flow of NH3 through flow controller 903.

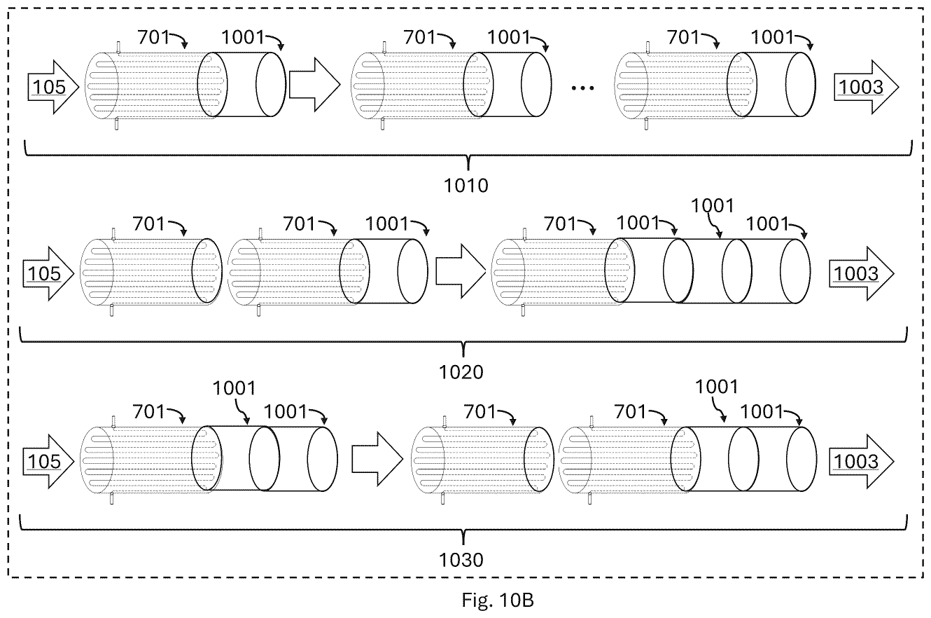

In some embodiments, the electrically heated reactor of FIG. 7 is coupled with passive reaction elements to increase contact time of a reactant fluid with a reforming or cracking catalyst. FIG. 10A shows one such embodiment where an electrically heated reactor 701 is fluidly connected to reactor element 1001 (which can be passive), located downstream of reactor 701. Reactor 701 receives reactant fluid 105 and produces reformed product stream 108. Reactor element 1001 receives hot effluent from reactor 701 (for example (“e.g.), partially converted NH3, reformed product stream 108), and further converts unreacted reactant without added or subtracted energy (i.e., adiabatic) producing stream 1002 with less reactant and more product than electrically heated reactor 701 effluent (reformed product stream 108). Because reforming reactions are endothermic, the temperature of the reactant and product fluid decreases as it passes through and reacts within reactor element 1001. Reactor element 1001 can be in the form of a packed bed of solid catalyst particles, extrudates, pellets, agglomerates, or tablets, metallic or ceramic particles or shapes coated with catalyst (e.g., catalyst coating 301, FIG. 3), or a honeycomb monolith of metallic or ceramic construction coated with catalyst (e.g., catalyst coating 301, FIG. 3). The catalyst used in reactor element 1001 can be the same catalyst coated onto the electrical heating elements of reactor 701, or a different catalyst.

In some embodiments, a multiplicity of electrically heated reactors can be arranged in series with passive, adiabatic, reactor elements. FIG. 10B shows a series of reactors wherein an electrically heated reactor 701 is in fluid communication with reactor element 1001, in fluid communication with additional heated reactors 701 and reactor elements 1001. Any number of electrically heated reactors can be arranged in series with any number of passive reactor elements, with examples shown in stack arrangements 1010, 1020, and 1030 which receive reactant fluid 105 and produce final product stream 1003. The multiplicity of electrically heated reactors 701 in any configuration, including configurations with or without reactor elements 1001, can be wired in series or in parallel or a combination of the two, and can be controlled with one or more controllers (e.g., power controller 922 in FIG. 9).

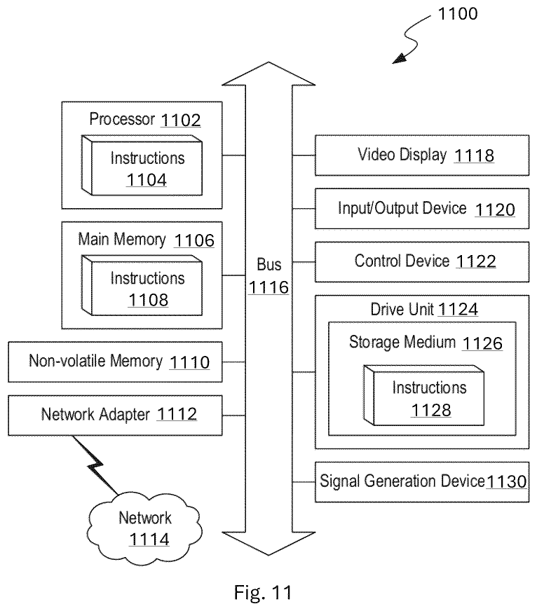

FIG. 11 is a block diagram illustrating an example computer system 1100. In one embodiment, components of computer system 1100 are used to implement and/or control the temperatures in the catalytic reformer described herein. At least some operations described herein can be implemented on computer system 1100.

Computer system 1100 can include one or more central processing units (“processors”) 1102, main memory 1106, non-volatile memory 1110, network adapters 1112 (e.g., network interface), one or more video displays 1118, input/output devices 1120, control devices 1122 (e.g., keyboard and pointing devices), drive units 1124 which can include storage medium 1126, and signal generation device 1130 that are communicably connected to bus 1116. In FIG. 11, bus 1116 is illustrated as an abstraction that represents one or more physical buses and/or point-to-point connections that are connected by appropriate bridges, adapters, or controllers. Bus 1116, therefore, can include a system bus, a Peripheral Component Interconnect (PCI) bus and/or PCI-Express bus, a HyperTransport or industry standard architecture (ISA) bus, a small computer system interface (SCSI) bus, a universal serial bus (USB), IIC (12C) bus, and/or an Institute of Electrical and Electronics Engineers (IEEE) standard 1394 bus (also referred to as “Firewire”). Input/Output device 1120 preferably includes connections to all sensors otherwise involved in the operation of the internal combustion engine, connected via one or more wiring harnesses into bus 1116.

Computer system 1100 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by computer system 1100.

While main memory 1106, non-volatile memory 1110, and storage medium 1126 (also called a “machine-readable medium”) are each illustrated as a single medium, the term “machine-readable medium” and “storage medium” are intended to include a single medium or multiple media (e.g., a centralized and/or distributed database and/or associated caches and servers) that store one or more sets of instructions 1108 and/or 1128. The term “machine-readable medium” and “storage medium” are also intended to include any medium that is capable of storing, encoding, or carrying a set of instructions for execution by computer system 1100.

In general, the routines executed to implement the embodiments of the present invention can be implemented as part of an operating system or a specific application, component, program, object, module, or sequence of instructions (collectively referred to as “computer programs”). The computer programs can include one or more instructions (e.g., instructions 1104, 1108, 1128) set at various times in various memory and storage devices in a computer device. When read and executed by one or more processors 1102, the instruction(s) cause computer system 1100 to perform operations to execute elements involving the various aspects of embodiments of the invention.

Network adapter 1112 preferably enables computer system 1100 to mediate data in a network 1114 with an entity that is external to computer system 1100 through any communication protocol supported by computer system 1100 and the external entity. Network adapter 1112 can include a network adapter card, a wireless network interface card, a router, an access point, a wireless router, a switch, a multilayer switch, a protocol converter, a gateway, a bridge, a bridge router, a hub, a digital media receiver, and/or a repeater.

Network adapter 1112 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

Embodiments of the present invention relate to metallic substrates heated via electrical resistance to an applied voltage, coated with a solid catalytic material, and applied to endothermic chemical reactions. Embodiments of the present invention also relate to methods of using an electrically heated catalyst to produce reformed fuel mixtures for internal combustion engines or combustion appliances.

In one embodiment, the present invention can be provided as a drop-in unit to retrofit onto existing internal combustion engines. Optionally, however, internal combustion engines can be constructed from the ground up and can incorporate embodiments of the present invention. Embodiments of the present invention can be incorporated into internal combustion engines that are mobile or stationary-including but not limited to generators, pumping stations, ships, vehicles, or heavy equipment, which can optionally include mining, construction and rail locomotives and equipment, and the like.

In one embodiment, the substrate can comprise an electrical heating element such that the catalyst is coated onto or otherwise applied directly to an electrical heating element. The electrical heating element, with catalyst, can then be disposed directly into a flow path of the feedstock.

In one embodiment, passive catalytic elements are disposed within a reactor assembly and in fluid communication with at least one electrically heated solid catalyst. The passive catalytic elements provide additional contact surface and reaction time for a reacting fluid thus heated and partially converted to H2 while passing over the electrically heated solid catalyst. Passive catalytic elements comprise a solid catalytic material suitable for reforming or cracking of a hydrogen-containing fluid and can be in the form of particles, pellets, extrudates, tablets, agglomerates, coated solid particles or shaped structures, or coated honeycomb monoliths. When coated onto a solid substrate, the solid catalyst can be formulated to adhere to ceramic or metallic surfaces that can optionally be pretreated chemically or thermally to improve the quality and uniformity of the solid catalyst coating. The passive catalyst element operates adiabatically, i.e., without the introduction or removal of energy from the flowing reactant fluid. As such, the temperature of the fluid changes only due to the removal of heat from the reaction mixture to satisfy the reaction endotherm, the energy of which becomes contained in the heating value of the reaction product(s).

In one embodiment, a multiplicity of electrically heated solid catalysts and passive catalytic elements are arranged in series to heat the fluid and solid catalyst and to provide for sufficient reaction time for a hydrogen-containing fluid to be cracked or reformed to a portion of H2 gas. Any number of electrically heated solid catalysts and passive catalytic elements can be arranged in any order to achieve a high conversion of the reactant chemical to H2 and byproducts.

In one embodiment, the catalyst can include a metal oxide support that is chemically bound to the metallic substrate and a catalytic metal that is bound to the metal oxide support. The metal oxide can include at least one of aluminum oxide, magnesium oxide, cerium oxide, lanthanum oxide, iron oxide, calcium oxide, barium oxide, titanium oxide, and/or praseodymium oxide. The metal oxide can optionally include at least one promoter, which can optionally include a promoter selected from sodium, potassium, cesium, rubidium, vanadium, magnesium, calcium, barium, and/or yttrium. The catalytic metal can be a pure metal, which can optionally include iron, cobalt, nickel, copper, palladium, ruthenium, rhodium, silver, molybdenum, tungsten, rhenium, osmium, and/or platinum. The catalytic metal can optionally be an alloy of two or more of iron, cobalt, nickel, copper, palladium, ruthenium, rhodium, silver, molybdenum, tungsten, rhenium, osmium, and/or platinum. The catalytic metal can include an active form of a nitride, oxide, carbide, oxynitride, and/or oxycarbide when exposed to reaction gas at reaction temperature. The substrate metal can be resistant to chemical attack by ammonia at reaction temperature and pressure. Optionally, the substrate metal can include an austenitic stainless steel and/or a nickel-containing alloy-most preferably one with at least about 50% nickel. The substrate metal can form a surface oxide through thermal and/or chemical pretreatments that enable chemical bonding between the surface oxide of the metallic substrate and the metal oxide support.

Embodiments of the present invention also relate to a method for reforming or cracking a fluid, whereby a hydrogen-containing chemical is converted to hydrogen gas and a chemical byproduct, the method including flowing the hydrogen-containing chemical across a solid catalyst that is coated or otherwise disposed on an electrically-heated metallic substrate; and maintaining a catalyst surface temperature at or about a predetermined temperature or temperature range by modulating power applied to the electrically-heated metallic substrate; and controlling the extent of reforming or cracking to hydrogen gas by modulating the flow of fluid across the catalyst on the electrically-heated metallic substrate and/or by modulating the catalyst surface temperature of the electrically-heated metallic substrate. The hydrogen-containing chemical can include one or more of ammonia, methane methanol, ethanol, petroleum naphtha, or natural gasoline. In one embodiment, the catalyst temperature is preferably maintained between about 350° C. and about 700° C. The hydrogen-containing chemical is preferably converted to hydrogen with a conversion of about 1% to about 99%, and in some embodiments preferably with a conversion of about 7% to a conversion of about 50% or, in one embodiment, with a conversion of about 95% to 100%. The extent of reforming or conversion can be controlled through a feedback loop wherein a process measurement of hydrogen concentration in the reformer exit (control input) is used in a control algorithm to adjust a control output (for example a temperature of the solid catalyst or the power applied to the electrically heated catalyst and/or a flow of hydrogen-containing chemical) to achieve the desired extent of reforming or conversion. The produced hydrogen gas can be used to improve the combustion of the hydrogen-containing chemical or another fuel in an internal combustion engine. The produced hydrogen gas can also be used to improve the combustion of the hydrogen-containing chemical in a furnace or burner.

### INDUSTRIAL APPLICABILITY

The invention is further illustrated by the following non-limiting hypothetical examples of possible applications for implementation of embodiments of the present invention.

### EXAMPLE 1

The assembly illustrated in FIG. 8 can optionally be used to produce brake power to turn a genset using a spark-ignited four-cycle engine. Anhydrous ammonia is vaporized and preheated in heat exchangers 805 and 808 then passed through a reactor comprising an electrically isolated coated metallic substrate located within an enclosed flow path, reactor 701. The substrate is preferably coated with an NH3 reforming catalyst comprising a porous promoted aluminum oxide impregnated with small particles of metallic ruthenium. The coating thickness is preferably between about 5 to about 100 micrometers, more preferably between about 10 to about 40 micrometers, and most preferably about 20 micrometers. The ruthenium catalyst particle size is preferably about 2 to about 20 nanometers, more preferably between about 5 to about 10 nanometers, and most preferably about 7 nanometers. . . . The temperature of the substrate is controlled at a temperature of preferably about 350° C. to about 650° C., more preferably about 400° C. to about 550° C., and most preferably about 500° C. by pulsing direct current (which can optionally derive, for example, from a 24 volt DC source) through a solid state relay to achieve a substrate surface temperature at a thermocouple welded to the substrate, using a velocity-type PID algorithm. At idle, the engine may require a mixture of about 1 to 1 of NH3 to H2 for proper operation, or about 40% conversion of the NH3. When a load is applied to the engine, the demand can change for example to a mixture of about 2 to 1 of NH3 to H2 as dictated by the engine control unit (ECU) of computer system 1100 (FIG. 11) while NH3 flow is increased. Power to the reactor 701 is preferably modulated to achieve the 2 to 1 NH3 to H2 mixture, with a change in NH3 conversion detected within about 1.5 seconds.

### EXAMPLE 2

The assembly illustrated in FIG. 8 can optionally be used to supplement power and reduce diesel consumption in a mining haulage truck using a four-cycle compression ignition engine. Anhydrous ammonia is preferably vaporized and preheated in heat exchangers 805 and 808 then passed through a reactor comprising an electrically isolated coated metallic substrate located within an enclosed flow path of reactor 701. The substrate is preferably coated with an NH3 reforming catalyst comprising a porous magnesium and cerium oxide catalyst support impregnated with small particles of metallic cobalt. The coating thickness is preferably between about 5 to about 100 micrometers, more preferably between about 20 to about 50 micrometers, and most preferably about 35 micrometers. The cobalt catalyst particle size is preferably about 2 to about 50 nanometers, more preferably between about 5 to about 30 nanometers, and most preferably about 20 nanometers. The temperature of the substrate is controlled at a temperature of preferably about 350° C. to about 650° C., more preferably about 400° C. to about 550° C., and most preferably of about 450° C. by pulsing a direct current (which can optionally derive, for example, from a 48 volt AC or DC source) through a solid state relay to achieve a substrate surface temperature at a thermocouple that is most preferably welded or otherwise coupled to the substrate, using a velocity-type PID algorithm. ECU of computer system 1100 (FIG. 11) preferably maintains a steady stream of reformed ammonia fuel with an average ammonia conversion of about 23% and adjusts diesel injection flow and timing to respond to changes in engine speed and load.

### EXAMPLE 3

The reactor of FIG. 7 can optionally be used to extract H2 from a dilute heated stream of vaporized methanol (CH3OH) in N2. The dilute methanol stream is preferably passed through a reactor comprising an electrically isolated coated metallic substrate located within an enclosed flow path, reactor 701. The substrate is preferably coated with a methanol reforming catalyst comprising an aluminum oxide catalyst support impregnated with small particles of metallic nickel. The coating thickness is preferably between about 5 to about 100 micrometers, more preferably between about 5 to about 25 micrometers, and most preferably about 10 micrometers. The nickel catalyst particle size is preferably about 2 to about 20 nanometers, more preferably between about 5 to about 15 nanometers, and most preferably about 11 nanometers. The temperature of the substrate is controlled at a temperature of preferably about 350° C. to about 750° C., more preferably about 500° C. to about 650° C., and most preferably of about 600° C. by pulsing alternating current (which can derive, for example, from a 48 volt AC source) through a solid state relay, which can optionally be supplied from a regulated power supply, to achieve a substrate surface temperature at a thermocouple that is welded or otherwise coupled to the substrate, using a velocity-type PID algorithm. Analysis of the product gases indicate a methanol concentration of less than about 2 parts per million and near complete conversion of the methanol to H2 and carbon monoxide (CO) should occur.

### EXAMPLE 4

An assembly similar to that illustrated in FIG. 8 is preferably used to supplement power and reduce diesel consumption in an NH3 tanker using a two-cycle compression ignition engine. Anhydrous NH3 can optionally be removed from the NH3 cargo, vaporized by exchange with heat from seawater, preheated in heat exchanger 808, and then passed through a reactor comprising an electrically isolated coated metallic substrate located within an enclosed flow path in reactor 701. The substrate is preferably coated with an NH3 reforming catalyst comprising a porous magnesium and cerium oxide catalyst support impregnated with small particles of metallic cobalt. The coating thickness is preferably between about 5 to about 100 micrometers, more preferably between about 20 to about 50 micrometers, and most preferably about 35 micrometers. The cobalt catalyst particle size is preferably about 2 to about 50 nanometers, more preferably between about 5 to about 30 nanometers, and most preferably about 20 nanometers. The temperature of the substrate is controlled at a temperature of preferably about 350° C. to about 650° C., more preferably about 400° C. to about 600° C., and most preferably of about 550° C. by pulsing an alternating current, which can optionally derive from a 50 volt supply from an alternator powered from an auxiliary engine, through a solid state relay to achieve a substrate surface temperature at a thermocouple that is welded or otherwise coupled to the substrate, (optionally using a velocity-type PID algorithm). ECU of computer system 1100 (FIG. 11) preferably maintains a steady stream of reformed ammonia fuel with an average ammonia conversion of about 36% and adjusts diesel or fuel oil injection flow to respond to changes in engine speed and load and to maintain low levels of nitrogen oxides in the engine exhaust.

### EXAMPLE 5

The assembly illustrated in FIG. 9 is preferably used to supply H2 to the propulsion engine of a bulk carrier to improve brake thermal efficiency, to reduce the consumption of marine diesel or heavy fuel oil, and to reduce pollutant emissions. A fuel replacement of about 5-15% of the diesel or fuel oil is desired, on an energy of combustion or lower heating value (LHV) basis. Liquid NH3 in tank 801 is metered into the system through flow controller 903, where it is vaporized in heat exchanger 905 with pumped seawater or engine exhaust, depending on the proximity of the exchanger to ship utilities and the exhaust stack. The vaporized NH3 flows through heat exchanger 907 where it is preheated to a temperature of about 110 degrees Celsius using low quality steam from the ship's boiler. The preheated NH3 flows next into economizer 910, which can optionally be formed in any desired manner, including but not limited to a plurality of brazed plate heat exchangers arranged in series, where it is further heated from hot effluent from reactor 701, entering reactor 701 at a temperature of about 400 degrees Celsius. Partially cooled effluent 912 exits economizer 910 at a temperature of about 260 degrees Celsius, where it releases heat in heat exchanger 812, immersed in fuel oil, to warm the fuel oil, reducing the effluent stream to a temperature of about 40 degrees Celsius. Hot NH3 gas enters reactor 701, constructed as a series of electrically heated catalysts and passive catalytic reactors depicted by stack arrangement 1010 in FIG. 10B, with five electrically heated catalysts and five passive catalytic reactors. Electrically heated catalysts in reactor 701 are constructed with ribbon-style heating elements coated with an NH3 reforming catalyst. Reactor elements 1001 (FIG. 10B) are constructed as metallic honeycomb monoliths coated with the same NH3 reforming catalyst. The five electrically heated reactors 701 are wired in parallel. Power from the ship's source 920, which may be a main power bus, is supplied at 440V, 3 phase, to transformer 921, which delivers between about 103 and about 206 volts to power controller 922. Power controller 922 uses a silicon-controlled rectifier (SCR) and pulse width modulation (PWM) to control the current delivered to stack arrangement 1010 (FIG. 10B). The total power delivered to the reforming reactor ranges from about 7.5 to 30 kilowatts (“kW”) to satisfy the range of engine demand for H2. Hot effluent containing less than about 1% NH3 and about 75% H2 and about 25% N2 at about 520 degrees Celsius flows to economizer 910 to preheat the incoming NH3 stream to the reformer stack. Cooled effluent gases from heat exchanger 812 flow into tank 930 (which may be an accumulator). Controller of computer system 1100 (FIG. 11) adjusts the flow of NH3 through flow controller 903 and the power delivered from power controller 922 to maintain a pressure in tank 930 at about 1 to about 2 bar higher than the required injection pressure for combustion device 950 and with a NH3 concentration less than about 1%. In this example, stack arrangements 1010 (FIG. 10B) are duplicated and arranged in parallel to increase reforming capacity to match engine size and associated H2 demand.

### EXAMPLE 6

The assembly and control method of Example 5 are used to provide H2 to burners at a cement kiln for green concrete production or a direct reduction shaft furnace for green steelmaking, with the burners represented by combustion device 950 in FIG. 9. Power from source 920 is provided by a local grid utility at 480V, 3 phase, instead of a ship power bus. Partially cooled effluent 912 is passed through heat exchanger 907 instead of heat exchanger 812 to cool the effluent to about 110 degrees Celsius before flowing directly into combustion device 950 (i.e., no use of heat exchanger 812 or tank 930). NH3 is vaporized in heat exchanger 905 using circulated glycol/water coolant at 80 degrees Celsius from a local air compression system instead of engine exhaust gases or seawater.

From the foregoing, it will be appreciated that the disclosed embodiments have been described herein for purposes of illustration, but that various modifications can be made without deviating from the scope of the disclosed embodiments. Accordingly, the disclosed embodiments are not limited.

Unless otherwise indicated, all number or expressions, such as those expressing dimensions, physical characteristics, etc., used in the specification (other than the claims) are understood as modified in all instances by the term “about”. Moreover, all ranges disclosed herein are to be understood to encompass and provide support for claims that recite any and all sub-ranges or any and all individual values subsumed therein. All percentages used throughout the specification and claims are weight percentages.

The preceding examples can be repeated with similar success by substituting the generically or specifically described components and/or operating conditions of embodiments of the present invention for those used in the preceding examples. The functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

The methods introduced here can be implemented by programmable circuitry (e.g., one or more microprocessors and/or microcontrollers), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably. Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

Optionally, embodiments of the present invention can include a general or specific purpose computer or distributed system programmed with computer software implementing steps described above, which computer software can be in any appropriate computer language, including but not limited to C, C++, FORTRAN, BASIC, Java, Python, Linux, assembly language, microcode, distributed programming languages, etc. The apparatus can also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given. All computer software disclosed herein can be embodied on any non-transitory computer-readable medium (including combinations of mediums), including without limitation hard drives (local or network storage device), USB keys, other removable drives, ROM, firmware, or any other media or device for storing data and/or software.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A system for reforming a hydrogen-containing feedstock comprising:
a housing at least partially defining an enclosed reactant fluid flow path;
an electrically conductive heating element substrate disposed within said enclosed reactant fluid flow path;
a catalyst coating disposed on at least a portion of said electrically conductive heating element substrate, said catalyst coating comprising a catalyst material capable of catalytically facilitating the conversion of a hydrogen-containing feedstock into hydrogen and a byproduct; and
at least one electrode disposed or otherwise formed onto said electrically conductive heating element substrate.

2. The system of claim 1, wherein said electrically conductive heating element substrate is formed from:
an austenitic stainless steel; or
nickel-containing alloy comprising at least 50% nickel; and wherein said electrically conductive heating element substrate comprises a surface oxide layer.

3. The system of claim 2, wherein said catalyst coating comprises a metal oxide support chemically bound to said surface oxide layer and wherein said catalyst coating further comprises a catalytic metal bound to said metal oxide support.

4. The system of claim 3, wherein said metal oxide support comprises at least one of aluminum oxide, magnesium oxide, cerium oxide, lanthanum oxide, iron oxide, calcium oxide, barium oxide, titanium oxide, and praseodymium oxide.

5. The system of claim 4, wherein said metal oxide support further comprises at least one of an alkali and an alkaline-earth promoter.

6. The system of claim 1, wherein said catalyst coating comprises at least one of metallic iron, cobalt, nickel, copper, palladium, ruthenium, rhodium, silver, molybdenum, tungsten, rhenium, osmium, platinum, nitrides, oxides, carbides, oxynitrides, oxycarbides and an alloy thereof.

7. The system of claim 1, wherein said housing defining an enclosed reactant fluid flow path comprises a plurality of housings defining an enclosed reactant fluid flow path and wherein said plurality of housings are arranged in series to provide a single continuous fluid flow path.

8. The system of claim 1, further comprising an additional catalytic reactor that does not comprise an electrically conductive heating element substrate, said additional catalytic reactor positioned downstream of said electrically conductive heating element substrate in said enclosed reactant fluid flow path.

9. The system of claim 8, wherein said additional catalytic reactor comprises a catalyst that is at least one of a particle, pellet, agglomerate, extrudate, tablet, coated ceramic solid, coated metallic solid, coated ceramic honeycomb monolith, and coated metallic honeycomb monolith.

10. The system of claim 1, wherein said housing and said electrically conductive heating element substrate are formed from one or more materials that are chemically tolerant of ammonia and hydrogen within a temperature range of 0 degrees Celsius to 650 degrees Celsius.

11. The system of claim 1, further comprising a controller configured to:
receive a process measurement indicative of hydrogen concentration in an outlet stream from said enclosed reactant fluid flow path;
compare the process measurement to a target corresponding to a desired partial conversion of said hydrogen-containing feedstock; and
adjust at least one of:
electrical power applied to said electrically conductive heating element substrate; and
a flow rate of said feedstock;
wherein said controller is configured to make the adjustment to maintain the hydrogen concentration within a predetermined range and/or to maintain the desired partial conversion within a predetermined range.

12. The system of claim 11, wherein said controller is further configured to:
receive a process measurement representing temperatures of fluid flowing through said enclosed flow path and/or in an outlet stream of said enclosed flow path;
compare one or more of the process measurements to the desired operating temperature; and
make the adjustment based thereon.

13. The system of claim 11, wherein said electrically conductive heating element substrate comprises at least one of a sheet, foil, wire, and a monolith.

14. The system of claim 1, configured for use as a fuel system for an internal combustion engine, said system further comprising:
a hydrogen-containing feedstock tank;
one or more heat exchangers configured to vaporize and preheat feedstock from said feedstock tank;
a power source, said power source electrically coupled to provide power to said electrically conductive heating element substrate; and
said enclosed reactant fluid flow path coupled such that it can receive the vaporized and preheated feedstock; and
a control unit configured to adjust at least one of:
electrical power to said electrically conductive heating element substrate; and
a flow of the hydrogen-containing feedstock.

15. The system of claim 14, wherein said control unit is configured to make the adjustment in response to at least one of engine load and fuel demand.

16. The system of claim 14, wherein said one or more heat exchangers are configured to derive heat from at least one of circulating engine coolant, engine exhaust, flue gas, seawater, and process steam.

17. The system of claim 14, wherein said power source comprises a battery that is connected such that it can be charged, at least partially, by work performed by said internal combustion engine.

18. The system of claim 14 wherein said power source comprises a power source that derives its energy from something other than said internal combustion engine.

19. The system of claim 14, wherein said fuel system is thermally and electrically integrated with said internal combustion engine.

20. The system of claim 14, wherein said fuel system is not thermally and electrically integrated with said internal combustion engine and instead is coupled to derive input energy from sources other than said internal combustion engine.

21. The system of claim 14, wherein:
said internal combustion engine comprises at least one of a two-stroke engine, a four-stroke engine, and a turbofan engine;
said internal combustion engine uses at least one of compression ignition and spark ignition; and
said internal combustion engine derives at least a portion of its combustion energy from hydrogen gas liberated by said catalyst coating on said electrically conductive heating element substrate.

22. A method of reforming a hydrogen-containing chemical, the method comprising:
flowing the hydrogen-containing chemical across a catalyst coated on an electrically conductive heating element substrate disposed within a flow path of the hydrogen-containing chemical to liberate hydrogen gas and byproducts;
making an adjustment to at least one of:
electrical power applied to the electrically conductive heating element substrate; and
a flow rate of the hydrogen-containing chemical; and
wherein making the adjustment comprises making the adjustment to maintain at least one of:
a hydrogen concentration;
a desired partial conversion of the hydrogen-containing chemical to the hydrogen gas; and
a temperature.

23. The method of claim 22, wherein the temperature comprises a temperature of the substrate and wherein the temperature comprises a temperature within a range of 250 degrees Centigrade to 850 degrees Centigrade.

24. The method of claim 22, wherein the desired partial conversion of the hydrogen-containing chemical to the hydrogen gas comprises an extent of conversion of between 7% and 99%.

25. The method of claim 22, wherein making an adjustment comprises making a step adjustment to the electrical power applied to the electrically conductive heating element substrate by at least 10% and causing a step change in the conversion of the hydrogen-containing chemical to the hydrogen gas and the byproducts within less than 5 seconds.

26. The method of claim 22, further comprising selecting the hydrogen-containing chemical, wherein selecting comprises selecting at least one element from the list consisting of ammonia, methanol, methane, ethanol, petroleum naphtha, and natural gasoline; and wherein the method further comprises operating the electrically conductive heating element substrate at a temperature sufficient to achieve at least 98% conversion of the hydrogen-containing chemical to the hydrogen gas and the by-products.

27. The method of claim 22, further comprising adding steam to the hydrogen-containing chemical and reducing the formation of carbon deposits on the catalyst while also causing a water gas shift reaction to produce more of the hydrogen gas.
